(19) United States
(12) Patent Application Publication
(10) Pub. No.: US 2024/0260120 A1
(43) Pub. Date: Aug. 1, 2024

(54) TRANSMISSION CONFIGURATION INDICATIONS FOR UPLINK TRANSMISSIONS USING MULTIPLE TRANSMISSION AND RECEPTION POINTS

(71) Applicant: ZTE Corporation, Shenzhen (CN)

(72) Inventors: Bo GAO, Shenzhen (CN); Zhaohua LU, Shenzhen (CN); Ke YAO, Shenzhen (CN); Meng MEI, Shenzhen (CN); Xiaolong GUO, Shenzhen (CN)

(21) Appl. No.: 18/611,428

(22) Filed: Mar. 20, 2024

Related U.S. Application Data
(63) Continuation of application No. PCT/CN2023/074158, filed on Feb. 1, 2023.

(51) Int. Cl. H04W 76/20; H04L 5/00; H04W 16/28; H04W 72/232

(52) U.S. Cl. CPC H04W 76/20; H04L 5/0051; H04W 16/28; H04W 72/232

(57) ABSTRACT

Methods, apparatus, and systems that relate to efficient indication of the beam states under the unified TCI framework for uplink channels and reference signal transmissions in multiple transmission and reception points. In one example aspect, a method for wireless communication includes determining one or more beam states associated with a transmission from a terminal device to a base station and performing the transmission according to the one or more beam states. One beam state is associated with multiple channels and reference signals.

### CROSS-REFERENCE TO RELATED APPLICATION

This application is a continuation and claims priority to International Application No. PCT/CN2023/074158, filed on Feb. 1, 2023, the disclosure of which is hereby incorporated by reference herein in its entirety.

### TECHNICAL FIELD

This patent document is directed to digital communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques that related to efficient indication of the beam states under the unified TCI framework for uplink channels and reference signal transmissions in multiple transmission and reception points.

In one example aspect, a method for wireless communication includes determining one or more beam states associated with a transmission from a terminal device to a base station, wherein multiple channels and reference signals are associated with a single beam state; and performing the transmission according to the one or more beam states.

In another example aspect, a communication apparatus is disclosed. The apparatus includes a processor that is configured to implement an above-described method.

In yet another example aspect, a computer-program storage medium is disclosed. The computer-program storage medium includes code stored thereon. The code, when executed by a processor, causes the processor to implement a described method.

The disclosed techniques can be used to implement a precoding matrix that is suitable for both near field and far field communications, thereby allowing flexible switches between the different types of communications. In addition, the disclosed techniques provide example ways of determining certain parameters of the precoding matrix so as to reduce the signaling overhead for indicating the precoding matrix and to allow the precoding matrix to match a communication channel between two wireless communication nodes.

These, and other, aspects are described in the present document.

### BRIEF DESCRIPTION OF DRAWINGS

FIG. 1 illustrates an example beam-based transmission between one transmission and reception point (TRP) and one User Equipment (UE) panel.

FIG. 2 illustrates an example multi-TRP operation in accordance with one or more embodiments of the present technology.

FIG. 3 illustrates an example association between beam states and target channel/reference signal for multi-TRP operations under the unified Transmission Configuration Indication (TCI) TCI framework in accordance with one or more embodiments of the present technology.

FIG. 4 illustrates a diagram for an example unified TCI framework for indicating downlink channels and reference signal transmissions in multi-TRP operations in accordance with one or more embodiments of the present technology.

FIG. 5 illustrates an example signaling framework in accordance with one or more embodiments of the present technology.

FIG. 6 illustrates an example for misalignment between Sounding Reference Signal (SRS) port and an effective beam state for a Physical Uplink Shared Channel (PUSCH) transmission in accordance with one or more embodiments of the present technology.

FIG. 7 is a flowchart representation of a method for wireless communication in accordance with one or more embodiments of the present technology.

FIG. 8 shows an example of a wireless communication system where techniques in accordance with one or more embodiments of the present technology can be applied.

FIG. 9 is a block diagram representation of a portion of a radio station in accordance with one or more embodiments of the present technology can be applied.

### DETAILED DESCRIPTION

Section headings are used in the present document only to improve readability and do not limit scope of the disclosed embodiments and techniques in each section to only that section. Furthermore, some embodiments are described with reference to Third Generation Partnership Project (3GPP) Fifth Generation (5G) New Radio (NR) or Sixth Generation (6G) standard for ease of understanding and the described technology may be implemented in different wireless system that implement protocols other than the NR or 6G protocol.

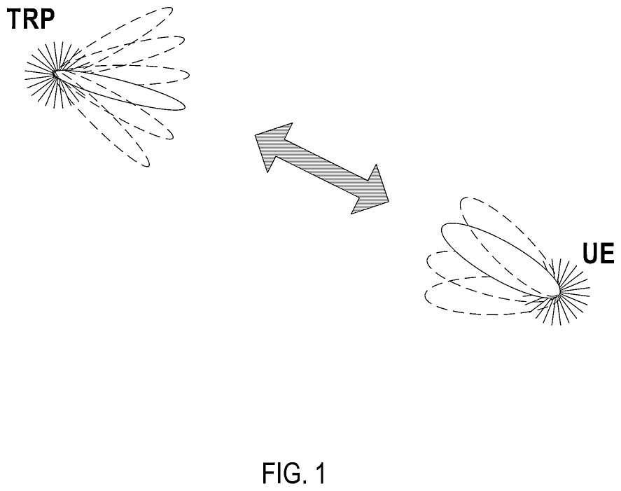

As the expense of wide or ultra-wide spectrum resources, the considerable propagation loss induced by the extremely high frequency becomes a noticeable challenge. To solve this, antenna array and beam-forming training technologies using massive Multiple-Input-Multiple-Output (MIMO) techniques, e.g., up to 1024 antenna elements for one node, have been adopted to achieve beam alignment and obtain sufficiently high antenna gain. To keep low implementation cost while still benefit from the antenna array, analog phase shifters become very attractive for implementing mmWave beam forming (BF), which means that the number of controllable phases is finite and the constant modulus constraints are placed on these antenna elements. Given the pre-specified beam patterns, the variable-phase-shift-based BF training targets to identify the best pattern for subsequent data transmission. FIG. 1 illustrates an example beam-based transmission between one transmission and reception point (TRP) and one User Equipment (UE) panel.

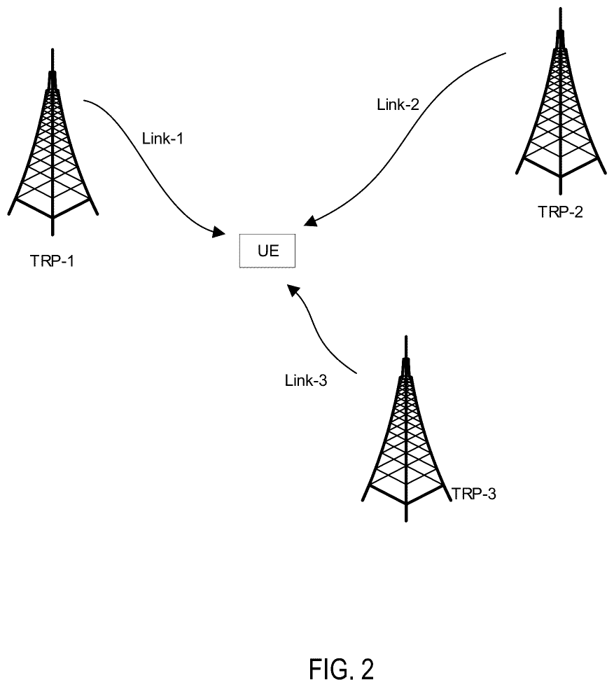

Multi-TRP (mTRP) operation has been considered as an emerging technique for balancing the deployment cost and throughput/robustness. FIG. 2 illustrates an example multi-TRP operation in accordance with one or more embodiments of the present technology. In multi-TRP operations, especially for Frequency Division Duplexing (FDD) or cell-edge UE in Time Division Duplexing (TDD), the Channel State Information (CSI) for determining downlink precoding, such as the Precoding Matrix Indicator (PMI), Rank Indicator (RI), Channel Quality Indicator (CQI), is reported from the UE to the base station. In some cases, even for a single transmission layer or a demodulation reference signal (DMRS) port, the precoding is provided for transmissions antennas across multi-TRPs accordingly.

In Long Term Evolution (LTE) systems, the information of the transmission configuration indicator (TCI) states has been flexibility adopted to show the mapping of the beam related information (e.g., between the reference signal, the Quasi-Co-Location (QCL) information, and the resources). However, the flexibility of the TCI state indication also brings significant signalling overhead. In 5G NR, a unified TCI framework has been adopted to the single TRP transmissions. The unified TCI framework associates a single TCI state (or a single beam state) with multiple channels and reference signals, including the Physical Downlink Control Channel (PDCCH), the Physical Downlink Shared Channel (PDSCH), the CSI Reference Signal (CSI-RS), the Physical Uplink Control Channel (PUCCH), the Physical Uplink Shared Channel (PUSCH) and/or the Sounding Reference Signal (SRS).

Extension of the unified TCI framework to multi-TRP operations, including non-coherent joint transmission (NCJT), coherent joint transmission (CJT) and single-frequency network (SFN), becomes urgent to enable efficient indication of the beam related information or beam states for mTRP operations. Several aspects need to be considered enable the efficient indication and determination of beam states under the unified TCI framework:

(1) For PUSCH transmissions that involve dynamic grant (DG) and configured grant (CG) cases, the dynamical indication of single TRP (sTRP) and mTRP transmission scheme (e.g., additionally indicate one or more beam states applicable to a given PUSCH transmission) and balancing of the different timeline between beam application and SRS transmission need to considered due to the fact that, besides spatial filtering information, the mapping between PUSCH and SRS antenna port(s) needs to be taken into account. The corresponding UL power control parameters need to be provided well.

(2) For SRS, the association between an SRS resource and a beam state needs to be specified, either explicitly or implicitly. Normal SRS transmissions as well as the group-common SRS triggering scheme need to be considered.

(3) In order to support unified TCI framework for CJT and SFN, the mechanism of providing two different power control parameters for a given transmission needs to be considered. There can be two different categories for providing mechanisms. For example, two power control parameter(s) can be applied to respective resource(s) of a UL data/channel RS. As another example, two power control parameter(s) can be both applicable to a UL data/channel RS.

This patent document discloses techniques that can be implemented in various embodiments to enable efficient indication of the beam/TCI states under the unified TCI framework for uplink channels and reference signal transmissions in multi-TRP operations (e.g., PUCCH, PUSCH, SRS). The disclosed techniques can provide a multi-TRP beam state indication framework without introducing unnecessary signalling overhead and enable dynamic point selection for multi-TRP operations and dynamic switching between multi-TRP (mTRP) and single-TRP (sTRP) operations.

### Terminology

The term “beam state” generally encompasses the relevant information related to beam forming in the communication. A “beam state” can be interchangeable with a quasi-co-location (QCL) state, a transmission configuration indicator (TCI) state, a spatial relation (also referred to as spatial relation information), a reference signal (RS) in the downlink or uplink direction, a spatial filter or a state of a spatial filter, and/or a pre-coding matrix (or precoding information). Furthermore, the “beam state” is also referred to as “beam.” Furthermore, the TCI state comprises at least one of a TCI state (e.g., joint TCI state, or a TCI state for both DL and UL) or a UL TCI state. Furthermore, a UL TCI state comprises one or more reference RS(s) but excludes QCL Type parameter.

Specifically, a “beam state” is associated with or comprises one or more reference RSs and/or their corresponding QCL type parameters, where QCL type parameters include at least one of the following aspect or combination: [1] Doppler spread, [2] Doppler shift, [3] delay spread, [4] average delay, [5] average gain, and [6] Spatial parameter. The definitions for ‘QCL-TypeA’, ‘QCL-TypeB’, ‘QCL-TypeC’, and ‘QCL-TypeD’ are as follows:
‘QCL-TypeA’:{Doppler shift, Doppler spread, average delay, delay spread}
‘QCL-TypeB’:{Doppler shift, Doppler spread}
‘QCL-TypeC’:{Doppler shift, average delay}
‘QCL-TypeD’:{Spatial Rx parameter}

The term “TCI state” is interchangeable with “beam state”.

The term “transmission (Tx) beam” can be interchangeable with a QCL state, a TCI state, a spatial relation state, a reference signal (e.g., CSI-RS, a synchronization signal block (SSB) that is also referred to as Synchronization Signal/Physical Broadcast Channel (SS/PBCH), a DMRS, an SRS, and/or a physical random access channel (PRACH)), a Tx spatial filter, or Tx precoding.

The term of “reception (Rx) beam” can be interchangeable with a QCL state, a TCI state, a spatial relation state, a Rx spatial filter, and/or Rx precoding.

The term of “beam identifier (ID)” can be interchangeable with a QCL state index, a TCI state index, a spatial relation state index, a reference signal index, a spatial filter index, or a precoding index.

The term “spatial relation information” includes one or more reference RSs that are used to represent the same or quasi-co spatial relation between a target RS/channel and one or more reference RSs.

The term “a spatial parameter” can be interchangeable with a spatial Tx parameter, a spatial Rx parameter, or a spatial filter. The spatial filter is also referred to as a spatial-domain filter. Specifically, the spatial filter can be either UE-side or gNB-side.

The term “channel” can be UL channel or DL channel.

The term “RS” can be UL RS or DL RS.

The term “UL channel” can be PUCCH or PUSCH.

The term “DL channel” can be PDCCH, or PDSCH.

The term “UL RS” can be SRS, PRACH, or DMRS for PUSCH and/or PUCCH.

The term “DL RS” can be SSB, CSI-RS, DMRS for PDSCH and/or PDCCH.

The term “UL signal” can be UL channel or UL RS (e.g., SRS, PRACH, DMRS, PUSCH or PUCCH).

The term “DL signal” can be DL channel or DL RS (SSB, CSI-RS, DMRS, PDSCH, or PDCCH).

The term “time unit” can be sub-symbol, symbol, slot, sub-frame, frame, or transmission occasion.

The term “a first beam state” includes at least on of: a beam state with first location, or a beam state with a specific identifier.

The term “a specific identifier” includes at least one of: a lowest identifier, a highest identifier, an identifier equal to 0, or an identifier equal to 1.

The term “selected beam state(s)” can be interchangeable with effective beam state(s), a pool of beam state(s), or indicated beam state(s).

The term “a power control parameter” includes one or more of: a target power (also referred to as P0), a path loss RS, a scaling factor for path loss (also referred as alpha), and/or a closed loop process. Notes that, the path-loss can be couple loss. Notes that, ‘a power control parameter’ can be interchanged with a UL power control parameter.

The term “DCI” is interchangeable with “PDCCH”.

The term “precoding information” includes at least one of: a Precoding Matrix Index (PMI), a Transmit Precoding Matrix Index (TPMI), a precoding, or a beam.

The term “TRP” is interchangeable with and can be represented by a RS port, a RS port group, RS resource, and/or a RS resource set.

The term “port group” is interchangeable with antenna group, or UE port group. The term “CSI report configuration” is interchangeable with CSI-AssociatedReportConfigInfo or CSI-ReportConfig. The term “a beam state is applied to a transmission” is interchangeable with “performing a transmission according to the beam state”.

### Unified Framework of Beam State Indication for Multi-TRP

Under the LTE/NR framework, one or more beam states (e.g., TCI states) can be indicated by a command (e.g., DCI or a MAC-CE command) for determining a QCL assumption of a DL signal, or a spatial relation/power control parameters for a UL signal. Under the unified TCI framework, instead of indicating one beam state per channel/reference signal in the downlink or uplink direction, the indicated beam state can be applicable to multiple channels/RSs. For multi-TRP operations, it is necessary to bring in “an anchor” to connect the association between a beam state and each of channels/RSs. In this document, such an anchor is referred to as an association entry or an association parameter.

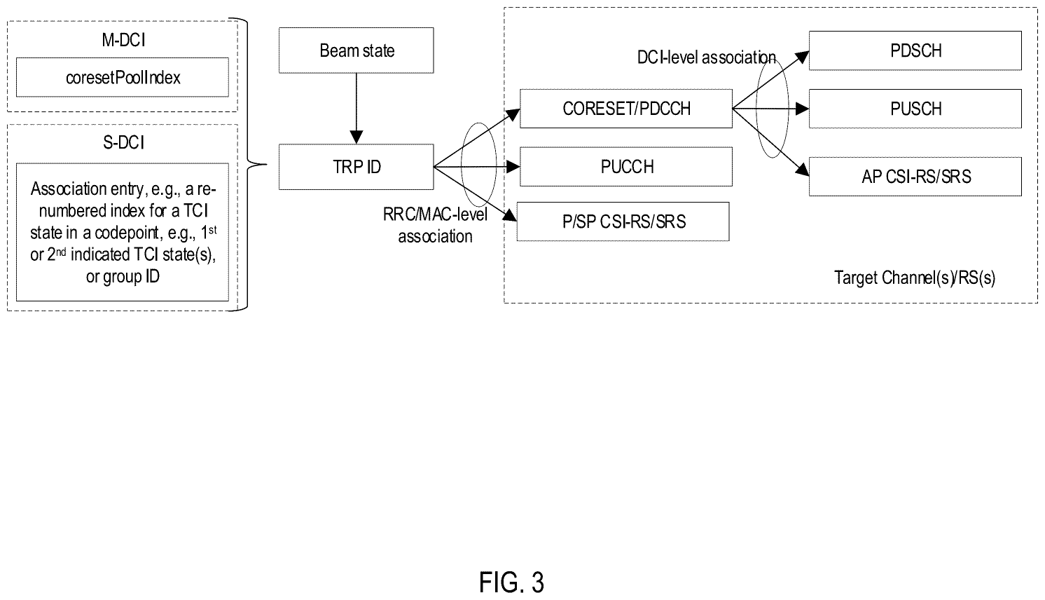

FIG. 3 illustrates an example association between beam states and target channel/reference signal for multi-TRP operations under the unified TCI framework in accordance with one or more embodiments of the present technology. The term “M-DCI” in FIG. 3 represents usage of multiple DCI signaling messages to schedule a mTRP transmission. The term “S-DCI” in FIG. 3 represents usage of a single DCI signaling message to schedule a mTRP transmission. A DCI signaling can be used as M-DCI or S-DCI without explicit distinctions in the DCI format(s) and/or fields. In the case of M-DCI, each DCI can be associated with a CORESET pool (e.g., via coresetPoolIndex) indicating the control resource set corresponding to the TRPs. The identifier of the CORESET pool (e.g., coresetPoolIndex) can thus function as the anchor (the association entry, the association parameter) to connect the beam state with the respective channel/reference signal.

In the case of S-DCI, a different or additional field can be used as the association entry to indicate the connection. At the MAC-CE level, when activating a plurality of TCI/beam codepoints, one or more beam state(s) can be activated for a beam codepoint and provided with a respective association entry. A beam/TCI codepoint includes a set of beam/TCI states, each having a respective index. The association entry can be a re-numbered index for a TCI state in a codepoint, e.g., 1^{st} beam state, 2^{nd} beam state, i-th beam state, 1^{st} beam state group, 2^{nd} beam state group, j-th beam state group. Herein, i and j denote an integer. Then one of the beam states can be indicated by a DCI message. Furthermore, the association parameter can include none (e.g., a null value). The ‘none’ (or the ‘null’ value) indicates that the channel/reference signal does not follow any one of the indicated beam/TCI states.

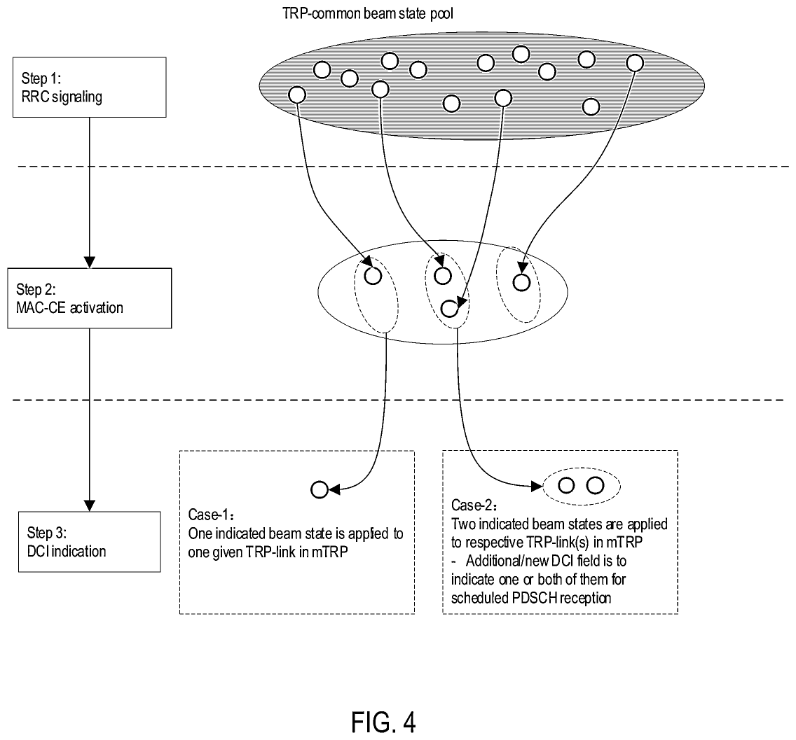

FIG. 4 illustrates a diagram for an example unified TCI framework for indicating downlink channels and reference signal transmissions in multi-TRP operations in accordance with one or more embodiments of the present technology. As shown in Case-1 of FIG. 4, DCI indication in step 3 can indicate a beam-state codepoint associated with a beam state. The association can be provided with an association entry (e.g., corresponding to the TRP or the first/second beam state). As shown in Case-2 of FIG. 4, DCI indication in step 3 can indicate a beam codepoint associated with two beam state(s). Each of them can be associated with a respective association entry corresponding to a TRP.

For M-DCI based mTRP operations, the association entry can be included in the MAC-CE command to be associated with an activated beam state. The association entry can be the control resource set pool identifier (e.g., CORESETPoolId). The activated beam state is then applied to a channel/RS associated with the same association entry.

### Beam and Power Control Indication for Dynamically Scheduling PUSCH

For S-DCI based mTRP operations, to accommodate channel changes (e.g., non-predicted link blockage), different transmission modes, such as dynamic switching between sTRP, NCJT, CJT and/or SFN mode, are considered. To support the dynamic switching, a new DCI filed can be provided to indicate which one or both of TCI states can apply to the scheduled PUSCH transmission. The indication can be a direct or explicit indication of the beam state. Alternatively, or in addition, the indication can be achieved by a mapping between a PUSCH port and SRS port(s) (e.g., from different SRS resource sets).

In some embodiments, in S-DCI based mTRP operations, spatial filter/power control indication can be achieved for PUSCH transmissions scheduled by DCI format 0_1/2 by one of the following:

Alternative 1-1: An existing field, such as the SRS resource set/resource indicator, can be used to indicate the mapping between the PUSCH port and the SRS. Furthermore, spatial filter indication can be implicitly derived based on the corresponding SRS resource or the beam state (e.g., TCI state) associated with SRS resource set. The beam state can be indicated by ‘SRS resource set/resource indicator’ at the time point of scheduled PUSCH transmission.

In some embodiments, UL power control parameter(s) can be determined according to the beam state applied to the indicated SRS. Several options are applicable:

Option 1-1: The PUSCH power control parameters are associated with the beam state (e.g., TCI state) based on the SRS transmission. For example, a PUSCH that is scheduled by a DCI at a slot n is transmitted at slot n+a. The SRS corresponding to the PUSCH transmission was transmitted at slot n−b. The UL power control parameters of the PUSCH are based on the UL power control parameters associated with beam state of the SRS at slot n−b.

Option 1-2: The PUSCH power control parameters are associated with the beam state (e.g., TCI state) at the time unit of the scheduled PUSCH transmission.

In some embodiments, the PUSCH power control parameters can be determined according to the TCI state associated with SRS resource set (e.g., indicated by ‘SRS resource set/resource indicator’) at the time unit of scheduled PUSCH transmission. For example, a PUSCH that is scheduled by a DCI at a slot n is transmitted at slot n+a. The SRS corresponding to the PUSCH transmission was transmitted at slot n−b. The UL power control parameters of the PUSCH are based on the UL power control parameters associated with beam state of the PUSCH transmission occasion at slot n+a.

Option 1-3: The PUSCH power control parameters are associated with the beam state (e.g., TCI state) at the time unit of scheduling PDCCH (e.g., the DCI) that schedules the PUSCH transmission. For example, a PUSCH that is scheduled by a DCI at a slot n is transmitted at slot n+a. The SRS corresponding to the PUSCH transmission was transmitted at slot n−b. The UL power control parameters of the PUSCH are based on the UL power control parameters associated with beam state of the DCI occasion at slot n.

Alternative 1-2: A new field, e.g., the beam state indication field or the TCI state indication field, can be used for AP-CSI-RS/PUSCH. The spatial filter and UL power control parameters for a PUSCH transmission are determined according to the beam state indicated by the beam state indication field in a DCI.

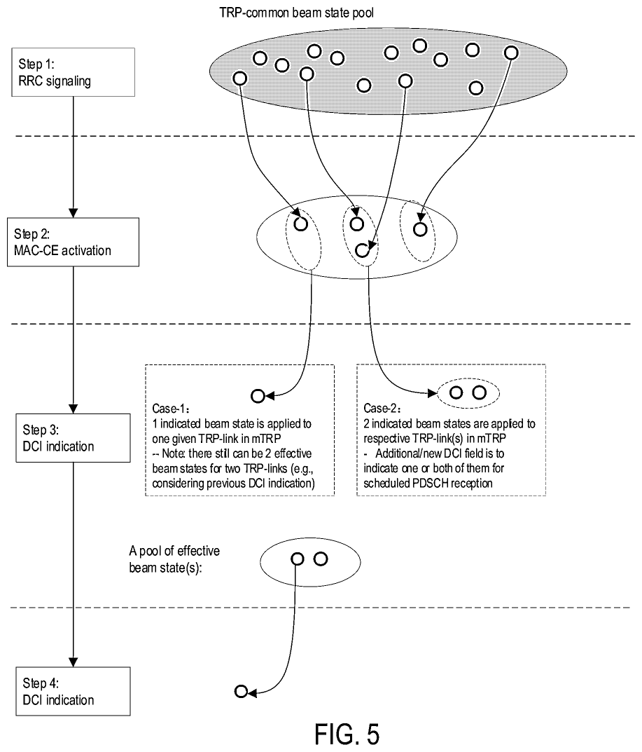

FIG. 5 illustrates an example signaling framework in accordance with one or more embodiments of the present technology. To apply a beam state to a PUSCH, a plurality of beam state(s) (e.g., TCI states) can be configured in a first command (e.g., a RRC signaling message). A second command (e.g., MAC-CE command) can activate one or more beam codepoints (e.g., TCI codepoints). Each of beam/TCI codepoints comprises one or more beam state(s) from the plurality of beam state(s). A third command that includes a beam codepoint field (e.g., TCI codepoint indication field) indicates a codepoint from the one or more beam codepoints. The beam state(s) corresponding to the codepoint can be applied to the transmission (or considered as effective beam state(s) for the transmission).

Finally, given a PUSCH transmission, a fourth command (e.g., a DCI message) that includes a beam state indication field (e.g., TCI state indication field) indicates one or more beam state(s) from the applicable/effective beam states. That is, the fourth command provides one or more association parameters by the beam state indication field. In some embodiments, for a given association entry/parameter, only one beam state is determined and applied. Furthermore, the beam state corresponding to the indicated codepoint is applied to the UL channel/RS associated with the same association entry as the beam state. That is, the one or more beam states are applied to the transmission, or a spatial filter for the transmission is same as a spatial filter for a Sounding Reference Signal (SRS) transmission associated with the transmission. In some embodiments, the applied beam state(s) are determined according to the time unit of PUSCH transmission. In some embodiments, the beam state is based on the time unit of the DCI transmission. In some embodiments, the SRS resource set field can be disabled or become ineffective in the DCI.

In some embodiments, the PUSCH is scheduled by DCI format 0_0 (e.g., without a field of SRS resource set or beam state indication field in the DCI). The spatial filter of the PUSCH (e.g., in S-DCI based mTRP operation) can be determined according to at least one of:

### (1) Beam State of a PUCCH Resource.

For example, the beam state of the PUCCH resource having a lowest identifier (ID) can be used. In some embodiments, the PUCCH resource has a lowest ID in a group (e.g., PUCCH resource group) associated with the DCI. The CORESET associated with the DCI can be configured with an association entry such that the PUCCH resource can also be determined based on the association entry.

### (2) The First Beam State, or a Beam State With Lowest ID.

In some embodiments, the first of the effective beam state(s) indicated by a beam codepoint is used. In some embodiments, the beam state with the lowest ID in the effective beam state(s) indicated by a beam codepoint is used.

### (3) A Beam State Flagged by MAC-CE or RRC.

### (4) A Beam State Associated With a Given Time Unit.

### (5) A Beam State Associated With (e.g., a Searching Space Set or a CORESET of) the PDCCH/DCI Scheduling the PUSCH.

If there is only one beam state in the CORESET, the beam state in the CORESET is applied. If two or more beam state(s) in the CORESET, in some embodiments, the two or more beam states are applied. In some embodiments, one specific beam state of the two or more beam states is applied. The one specific beam state comprises at least one of the following schemes: (1) the first beam state of the two or more beam states, (2) a beam state that is pre-determined per CORESET or searching space set. Which one of the schemes is applicable is based on UE capability and/or configurations indicated by RRC or MAC-CE signaling.

### (6) The Beam State of a CORESET Associated With Lowest ID.

In some embodiments, the CORESET is associated with the same association entry as the PUSCH. In some embodiments, the CORESET is monitored. In some embodiments, the CORESET with lowest ID is in latest slot, e.g., beam state associated with CORESET with lowest ID in latest slot.

In some embodiments, in S-DCI based mTRP operation, the power control parameters of the PUSCH are determined according to at least one of: (1) the UL power control parameters associated with the above identified beam state, (2) the UL power control parameters associated with beam state with lowest ID, and/or (3) the UL power control parameters in a set associated with lowest ID.

In some embodiments, e.g., in M-DCI based mTRP operations where the CORESETPooldId is configured, the UL power control of the PUSCH scheduled by DCI format 0_0 is determined according to UL power control associated with the same CORESETPooldId as PDCCH/CORESET scheduling the PUSCH. For example, to determine the beam state, the UE applies the indicated joint/UL TCI state specific to a coresetPoolIndex value to PUSCH transmission scheduled/activated by PDCCH (e.g., DG-PUSCH and/or Type2 CG-PUSCH) on a CORESET that is associated with the same coresetPoolIndex value.

### Beam and Port Determination for Dynamically Scheduling PUSCH

The beam state applied to the PUSCH and SRS transmission can be determined based on the beam application time. For example, the beam state is applied starting from the first slot that is at least beamAppTime symbols after the last symbol of the PUCCH or the PUSCH carrying the HARQ-ACK corresponding to the DCI carrying beam codepoint update. However, after the first slot but before the first codebook (CB) based or non-codebook (NCB) based SRS transmission, the mapping between PUSCH and SRS antenna ports is still based on the previous/most recent SRS transmission (e.g., based on the previous beam). Using the same antenna port means that the PUSCH and SRS would experience the similar small-scale channel property. That means that there may be a misalignment between SRS port and effective beam state for PUSCH (e.g., determined based on the time unit of scheduled PUSCH transmission).

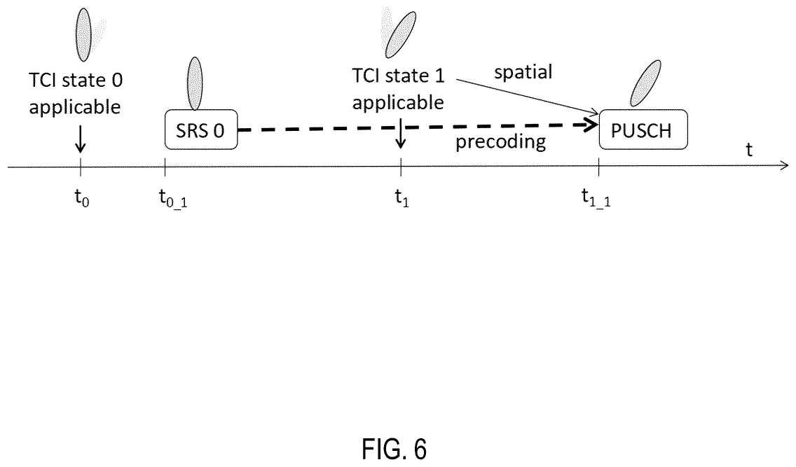

FIG. 6 illustrates an example for misalignment between SRS port and effective beam state for PUSCH in accordance with one or more embodiments of the present technology. The effective beam state for PUSCH is based on the time unit of scheduled PUSCH transmission or scheduling DCI/PDCCH. At least one of the following needs to be taken into consideration to ensure the same understanding between spatial filter and precoding determination.

In some embodiments, the UE can use a spatial filter of the corresponding SRS transmission for a PUSCH transmission. The spatial filter of the corresponding SRS transmission can be applied when the spatial filter of the corresponding SRS transmission is different from that indicated/effective beam state, or when the PUSCH is scheduled by DCI format 0_1/2. For example, when an SRI corresponding to the UL transmission is indicated to the UE and the UE is configured with TCI state (e.g., unified TCI or UL-TCI State), if the spatial domain transmission filter associated with the indicated SRI is different from the spatial domain receive filter that the uses to receive the DL reference signal associated with the indicated TCI state, the UE can use a spatial domain filter that is same as the spatial domain transmission filter associated with the indicated SRS resource(s).

In some embodiments, the beam state for PUSCH transmission is applied after most recent SRS transmission where the indicated beam state is applied. Only when the corresponding SRS transmission occurs, the spatial filter/beam state for the PUSCH transmission is applied. For example, for codebook based or non-codebook based PUSCH transmissions, the indicated TCI state (for DL and UL and/or DL-only) or UL-TCI state is applied after most recent SRS transmission wherein the indicated TCI state or UL-TCI state is applied.

Beam and Power Control Indication for Configured Grant PUSCH in M-DCI Based mTRP

In some embodiments, in M-DCI based MTRP, the coresetPoolIndex or association entry can be configured per CG-PUSCH configuration. The beam state associated with the same coresetPoolIndex can be applied to the CG-PUSCH transmission. Alternatively, or in addition, the beam state associated with the same association entry is applied to the CG-PUSCH transmission.

In some embodiments, the spatial filter and/or the UL power control parameter(s) are determined according to the beam state (e.g., TCI state) applied to the SRS transmission (e.g., most recent SRS transmission) indicated by RRC parameter in the CG-PUSCH configuration.

In some embodiments, the spatial filter and/or UL power control parameter(s) are determined according to the beam state (e.g., TCI state) at the CG-PUSCH transmission. In some embodiments, the CG-PUSCH configuration is associated with SRS resource(s) in the set associated with the same coresetPoolIndex or association entry.

In some embodiments, SRS resource set indicator can be configured per CG-PUSCH configuration. In those cases, the given SRS resource(s) can be clearly determined according to SRS resource indicator(s) and/or the SRS resource set indicator. The UL power control parameters can be determined according to the beam state associated with the corresponding SRS resource (set). In some embodiments, one or more parameters such as the path loss RS is determined according to the above. The other parameter (e.g., P0/alpha) can be determined according to the original parameter.

Beam and Power Control Configuration for SRS in mTRP

For S-DCI based mTRP operations, more than one beam state(s) can be associated with one activated beam codepoint in MAC-CE. For aperiodic (AP)-SRS, the association parameter/association entry (e.g., the first, second or both beam/TCI states) can be configured per SRS resource, SRS resource set, or SRS triggering state. For SRS triggering state, the mapping between association entry/parameter and SRS resource set(s) can be one-by-one, or one-to-more in a particular order. For semi-persistent (SP)/periodic(P)-SRS, the association parameter/association entry (e.g., the first, second or both beam/TCI states) can be configured per SRS resource or SRS resource set.

For M-DCI based mTRP operation (e.g., an association parameter/entry such as CORESETPoolId is provided in a CORESET), the following can be considered. For P/SP-SRS, the association parameter (e.g., CORESETPoolId, the first, second or both TCI states) can be configured per SRS resource, or SRS resource set. For AP SRS, two options can be considered.

Option 2-1: the association parameter/entry (e.g., CORESETPooldId, the first, second or both TCI states) can be configured per SRS resource, SRS resource set, or SRS triggering state.

Option 2-2: CORESETPoolId is determined according to the PDCCH/CORESET triggering the SRS.

In some embodiments, the beam state is associated with an association parameter or CORESETPooldId. The UL power control parameters associated with the beam state are applied to the SRS resource associated with the same association parameter or the same CORESETPooldId. Furthermore, the application of the UL power control parameters is determined according to the time unit of SRS transmission.

In some embodiments, a time-domain parameter (e.g., time domain offset) can be associated with beam state. For instance, the time-domain parameter (e.g., time domain offset) can be provided simultaneously (in the TCI state).

In some embodiments, for SP-SRS, when activating an SRS transmission, the association parameter can be provided in MAC-CE.

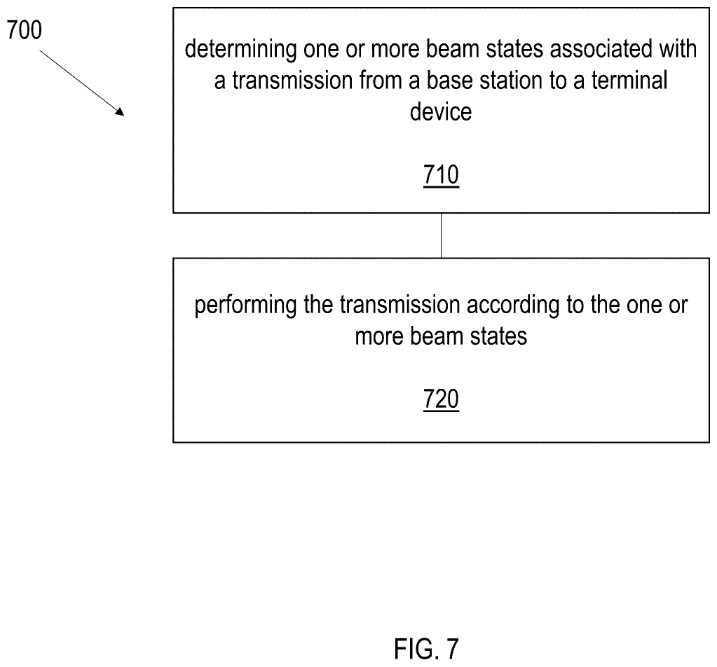

FIG. 7 is a flowchart representation of a method 700 for digital communication in accordance with one or more embodiments of the present technology. The method 700 includes, at operation 710, determining one or more beam states associated with a transmission from a terminal device to a base station. Multiple channels and reference signals are associated with a single beam state. The method 700 includes, at operation 720, performing the transmission according to the one or more beam states. A beam state comprises at least one of a transmission configuration indicator (TCI) state, a quasi-co-location (QCL) state, a spatial relation, a reference signal (RS), a spatial filter, or a pre-coding matrix. A beam state corresponds to at least one of: a port associated with the transmission, a port group associated with the transmission, a reference signal resource associated with the transmission, or a reference signal resource set associated with the transmission. The transmission comprises at least one of a physical uplink control channel (PUCCH) transmission, a physical uplink shared channel (PUSCH) transmission, or a sounding reference signal (SRS) transmission. In some embodiments, the transmission is performed according to a spatial filter associated with the one or more beam states or a power control parameter associated with the one or more beam states.

In some embodiments, the method includes transmitting, by the base station to the terminal device, a first signaling message (e.g., RRC) configuring a plurality of beam states and transmitting, by the base station, a second signaling message (e.g., MAC CE) to the terminal device. The second signaling message activates one or more beam codepoints. Each of the one or more beam codepoints corresponds to at least one beam state of the plurality of beam states. The method includes transmitting, by the base station, a first Downlink Control Information (DCI) message to the terminal device. The first DCI message comprises a first field indicating a beam codepoint from the one or more beam codepoints activated by the second signaling message. A pool of beam states or selected beam state(s) is determined according to the beam codepoint. The method also includes transmitting, by the base station, a second DCI message to the terminal device scheduling the transmission. The method further includes applying the one or more beam states to the transmission (the one or more beam states being from the selected beam states or a specific beam state), or performing the transmission by a spatial filter that is same as a spatial filter for a Sounding Reference Signal (SRS) transmission associated with the transmission.

In some embodiments, the method includes receiving, by a terminal device, a first signaling message (e.g., RRC) from the base station configuring a plurality of beam states and receiving, by the terminal device from the base station, a second signaling message (e.g., MAC CE) activating one or more beam codepoints. Each of the one or more beam codepoints corresponds to one or more beam states of the plurality of beam states. The method includes receiving, by the terminal, a first Downlink Control Information (DCI) message from the base station scheduling the transmission. The first DCI message comprises a first field indicating a beam codepoint from the one or more beam codepoints activated by the second signaling message. The method also includes determining a pool of beam states or selected beam state(s) according to the beam codepoint and receiving, by the terminal device, a second DCI message from the base station scheduling the transmission. The method further includes applying the one or more beam states the transmission (the one or more beam states being from the selected beam states or a specific beam state), or performing the transmission by a spatial filter that is same as a spatial filter for a Sounding Reference Signal (SRS) transmission associated with the transmission.

In some embodiments, a second field is present in the second DCI signaling message indicating the one or more beam states from the pool of beam states (e.g., from the selected beam state(s)). In some embodiments, the second field comprises a Sounding Reference Signal (SRS) resource indicator or an SRS resource set indicator. In some embodiments, the SRS resource indicator or SRS resource set indicator in the second DCI signaling message is inactive in response to the second field being present in the second DCI signaling message.

In some embodiments, the spatial filter for the transmission is same as the spatial filter for an SRS transmission associated with the transmission in response to at least one of: at least one spatial filter associated with the pool of beam states (e.g., the selected beam state(s)) or indicated by the second field is different from a spatial filter used for the SRS transmission, or at least one beam state of the pool of beam states (e.g., at least one beam state of the selected beam state(s))or beam states indicated by the second field is different from a beam state associated with the SRS transmission.

In some embodiments, the one or more beam states from the pool of beam states (e.g., from the selected beam state(s)) are applied to the transmission after the one or more beam states are applied in an SRS transmission that is most recent to the transmission. In some embodiments, one or more power control parameters for the transmission are determined based on a beam state applied to the SRS transmission associated with the transmission.

In some embodiments, the beam state applied to the SRS transmission is determined according to at least one of: a time unit of the transmission corresponding to the SRS transmission, a time unit of the transmission, or a time unit of the second DCI message. In some embodiments, the beam state applied to the SRS transmission is determined according to the beam state associated with resource or resource set corresponding to the SRS transmission, and the resource or resource set is associated with the transmission.

In some embodiments, one or more power control parameters for the transmission are determined based on a beam state applied at a time unit of the transmission. In some embodiments, one or more power control parameters for the transmission are determined based on a beam state applied at a time unit of the second DCI message that schedules the transmission. In some embodiments, the second DCI message comprises a format that is least one of a DCI format 0_1 or a DCI format 0_2.

In some embodiments, a second field is absent in the second DCI message indicating the beam state from the pool of beam states (e.g., from the selected beam state(s)), or the second DCI message comprises a DCI format 0_0. In some embodiments, the specific beam state or all of selected beam states are applied to the transmission is based on a capability of the terminal device or a configuration parameter.

In some embodiments, the specific beam state is applied to the transmission and a spatial filter of the transmission is derived based on the specific beam state. In some embodiments, the specific beam state is applied to the transmission and one or more power control parameters for the transmission are determined on the specific beam state. In some embodiments, the specific beam state comprises at least one of: a beam state of a Physical Uplink Control Channel (PUCCH) resource having a specific identifier, a first beam state, a beam state having a specific identifier, a beam state indicated by a higher layer signaling message comprising a Medium Access Control (MAC) control element (CE) or a Radio Resource Control (RRC) signaling, a beam state associated with a specific time unit, a beam state associated with a search space set or a control resource set. In some embodiments, the specific beam state is associated with the Physical Uplink Control Channel (PUCCH) resource that has a specific identifier is from a PUCCH resource group associated with the second DCI message. In some embodiments, the control resource set has a specific identifier, is associated with the transmission, is monitored, or is in a latest slot of the transmission. In some embodiments, the first beam state comprises a first beam state in the pool of beam states (e.g., in the selected beam state(s)) or a first beam state in the indicated codepoint or the beam state having a specific identifier comprises a beam state in the pool of beam states (e.g., from the selected beam state(s)) or a beam state having a specific identifier in the indicated codepoint.

In some embodiments, more than one beam states are applied to a control resource set or a search space set associated with the transmission, and one specific beam state is applied to the transmission. The specific beam comprises at least one of: a first beam state of the more than one beam states, a first beam state in effective beam states, or a beam state configured for the control resource set or the search space set.

In some embodiments, the determining is based on an association parameter carried in a DCI signaling message. In some embodiments, the association parameter comprises a control resource set pool identifier. In some embodiments, the transmission is based on a configured grant. The beam state indicated by the association parameter is applied to the transmission. In some embodiments, a spatial filter or power control parameters of the transmission are determined based on the beam state indicated by the association parameter for the transmission. In some embodiments, a spatial filter or power control parameters of the transmission are determined based on the beam state applied in an SRS transmission that is most recent to the transmission. In some embodiments, an SRS resource set indicator is configured for a configured grant configuration, and power control parameters of the transmission are determined based on a beam state associated with an SRS resource set indicated by the SRS resource set indicator.

In some embodiments, an association between an SRS transmission with the beam state is indicated by an association parameter, the associated parameter provided in a MAC CE or a DCI signaling message. In some embodiments, the association parameter comprises a control resource set pool identifier. In some embodiments, the association parameter is configured for a SRS resource, for a SRS resource set, or for a SRS triggering state. In some embodiments, the association has a one-to-one or one-to-many correspondence with one or more SRS resource sets. In some embodiments, the association parameter is determined according to a triggering of the SRS transmission. In some embodiments, the beam state indicated by the association parameter and power control parameters associated with the beam state are applied to an SRS transmission that is associated with the same association parameter.

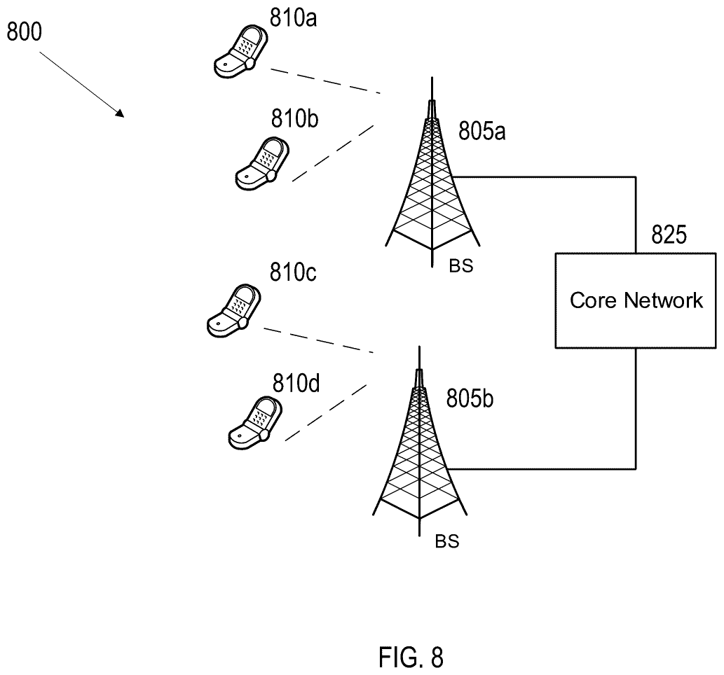

FIG. 8 shows an example of a wireless communication system 800 where techniques in accordance with one or more embodiments of the present technology can be applied. A wireless communication system 800 can include one or more base stations (BSs) 805a, 805b, one or more wireless devices (or UEs) 810a, 810b, 810c, 810d, and a core network 825. A base station 805a, 805b can provide wireless service to user devices 810a, 810b, 810c and 810d in one or more wireless sectors. In some implementations, a base station 805a, 805b includes directional antennas to produce two or more directional beams to provide wireless coverage in different sectors. The core network 825 can communicate with one or more base stations 805a, 805b. The core network 825 provides connectivity with other wireless communication systems and wired communication systems. The core network may include one or more service subscription databases to store information related to the subscribed user devices 810a, 810b, 810c, and 810d. A first base station 805a can provide wireless service based on a first radio access technology, whereas a second base station 805b can provide wireless service based on a second radio access technology. The base stations 805a and 805b may be co-located or may be separately installed in the field according to the deployment scenario. The user devices 810a, 810b, 810c, and 810d can support multiple different radio access technologies. The techniques and embodiments described in the present document may be implemented by the base stations of wireless devices described in the present document.

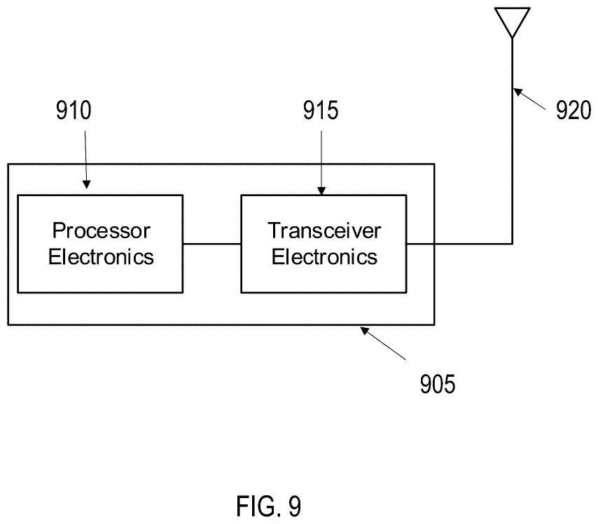

FIG. 9 is a block diagram representation of a portion of a radio station in accordance with one or more embodiments of the present technology can be applied. A radio station 905 such as a network node, a base station, or a wireless device (or a user device, UE) can include processor electronics 910 such as a microprocessor that implements one or more of the wireless techniques presented in this document. The radio station 905 can include transceiver electronics 915 to send and/or receive wireless signals over one or more communication interfaces such as antenna 920. The radio station 905 can include other communication interfaces for transmitting and receiving data. Radio station 905 can include one or more memories (not explicitly shown) configured to store information such as data and/or instructions. In some implementations, the processor electronics 910 can include at least a portion of the transceiver electronics 915. In some embodiments, at least some of the disclosed techniques, modules or functions are implemented using the radio station 905. In some embodiments, the radio station 905 may be configured to perform the methods described herein.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method for wireless communication, comprising:
transmitting, by a base station to a terminal device, a first signaling message configuring a plurality of TCI states;
transmitting, by the base station, a second signaling message to the terminal device, the second signaling message activating one or more codepoints, wherein each of the one or more codepoints corresponds to at least one TCI state of the plurality of TCI states;
transmitting, by the base station, a first Downlink Control Information (DCI) message to the terminal device, wherein the first DCI message comprises a first field indicating a codepoint from the one or more codepoints activated by the second signaling message, wherein selected TCI states are determined according to the codepoint;
transmitting, by the base station, a second DCI message to the terminal device scheduling a transmission, wherein one or more TCI states are applied to the transmission, the one or more TCI states being from the selected TCI states or a first TCI state; and
performing the transmission according to the one or more TCI states, wherein the transmission is performed according to a spatial filter associated with the one or more TCI states or a power control parameter associated with the one or more TCI states.

2. The method of claim 1, wherein a second field being present in the second DCI message indicates the one or more TCI states from the selected TCI states, wherein the second field comprises a Sounding Reference Signal (SRS) resource set indicator.

3. The method of claim 1, wherein the second DCI message comprises a DCI format 0_0, wherein whether the first TCI state is applied to the transmission is based on a configuration parameter.

4. The method of claim 1, wherein, upon the first TCI state being applied to the transmission, a spatial filter of the transmission is derived based on the first TCI state and one or more power control parameters for the transmission are determined on the first TCI state.

5. The method of claim 1, wherein the one or more TCI states are determined based on an association parameter, wherein the association parameter comprises a control resource set pool identifier, and wherein a power control parameter of the transmission is determined according to a TCI state that is associated with a same association parameter as a control resource set of the second DCI message scheduling the transmission.

6. A method for wireless communication, comprising:
receiving, by a terminal device, a first signaling message from a base station configuring a plurality of TCI states;
receiving, by the terminal device from the base station, a second signaling message activating one or more codepoints, wherein each of the one or more codepoints corresponds to at least one TCI state of the plurality of TCI states;
receiving, by the terminal device, a first Downlink Control Information (DCI) message from the base station, wherein the first DCI message comprises a first field indicating a codepoint from the one or more codepoints activated by the second signaling message;
determining selected TCI states according to the codepoint; and
receiving, by the terminal device, a second DCI message from the base station scheduling a transmission, wherein one or more TCI states are applied to the transmission, the one or more TCI states being from the selected TCI states or a first TCI state; and
performing the transmission according to the one or more TCI states, wherein the transmission is performed according to a spatial filter associated with the one or more TCI states or a power control parameter associated with the one or more TCI states.

7. The method of claim 6, wherein a second field being present in the second DCI message indicates the one or more TCI states from the selected TCI states, wherein the second field comprises a Sounding Reference Signal (SRS) resource set indicator.

8. The method of claim 6, wherein the second DCI message comprises a DCI format 0_0, wherein whether the first TCI state is applied to the transmission is based on a configuration parameter.

9. The method of claim 6, wherein, upon the first TCI state being applied to the transmission, a spatial filter of the transmission is derived based on the first TCI state and one or more power control parameters for the transmission are determined on the first TCI state.

10. The method of claim 6, wherein the one or more TCI states are determined based on an association parameter, wherein the association parameter comprises a control resource set pool identifier, and wherein a power control parameter of the transmission is determined according to a TCI state that is associated with a same association parameter as a control resource set of the second DCI message scheduling the transmission.

11. A device for wireless communication, comprising at least one processor that is configured to:
transmit, to a terminal device, a first signaling message configuring a plurality of TCI states;
transmit by a second signaling message to the terminal device, the second signaling message activating one or more codepoints, wherein each of the one or more codepoints corresponds to at least one TCI state of the plurality of TCI states;
transmit a first Downlink Control Information (DCI) message to the terminal device, wherein the first DCI message comprises a first field indicating a codepoint from the one or more codepoints activated by the second signaling message, wherein selected TCI states are determined according to the codepoint;
transmit a second DCI message to the terminal device scheduling a transmission, wherein one or more TCI states are applied to the transmission, the one or more TCI states being from the selected TCI states or a first TCI state; and
perform the transmission according to the one or more TCI states, wherein the transmission is performed according to a spatial filter associated with the one or more TCI states or a power control parameter associated with the one or more TCI states.

12. The device of claim 11, wherein a second field being present in the second DCI signaling message indicates the one or more TCI states from the selected TCI states, wherein the second field comprises a Sounding Reference Signal (SRS) resource set indicator.

13. The device of claim 11, wherein the second DCI message comprises a DCI format 0_0, wherein whether the first TCI state is applied to the transmission is based on a configuration parameter.

14. The device of claim 11, wherein, upon the first TCI state being applied to the transmission, a spatial filter of the transmission is derived based on the first TCI state and one or more power control parameters for the transmission are determined on the first TCI state.

15. The device of claim 11, wherein the at least one processor is configured to determine the one or more TCI states from the selected TCI states based on an association parameter, wherein the association parameter comprises a control resource set pool identifier, and wherein a power control parameter of the transmission is determined according to a TCI state that is associated with a same association parameter as a control resource set of the second DCI message scheduling the transmission.

16. A device for wireless communication, comprising at least one processor is configured to:
receive a first signaling message from a base station configuring a plurality of TCI states;
receive, from the base station, a second signaling message activating one or more codepoints, wherein each of the one or more codepoints corresponds to at least one TCI state of the plurality of TCI states;
receive a first Downlink Control Information (DCI) message from the base station,
wherein the first DCI message comprises a first field indicating a codepoint from the one or more codepoints activated by the second signaling message;
determine selected TCI states according to the codepoint;
receive a second DCI message from the base station scheduling a transmission, wherein one or more TCI states are applied to the transmission, the one or more TCI states being from the selected TCI states or a first TCI state; and
perform the transmission according to the one or more TCI states, wherein the transmission is performed according to a spatial filter associated with the one or more TCI states or a power control parameter associated with the one or more TCI states.

17. The device of claim 16, wherein a second field being present in the second DCI message indicates the one or more TCI states from the selected TCI states, wherein the second field comprises a Sounding Reference Signal (SRS) resource set indicator.

18. The device of claim 16, wherein the second DCI message comprises a DCI format 0_0, wherein whether the first TCI state is applied to the transmission is based on a configuration parameter.

19. The device of claim 16, wherein, upon the first TCI state being applied to the transmission, a spatial filter of the transmission is derived based on the first TCI state and one or more power control parameters for the transmission are determined on the first TCI state.

20. The device of claim 16, wherein the at least one processor is configured to determine the one or more TCI states from the selected TCI states based on an association parameter, wherein the association parameter comprises a control resource set pool identifier, and wherein a power control parameter of the transmission is determined according to a TCI state that is associated with a same association parameter as a control resource set of the second DCI message scheduling the transmission.
